(19) United States
(12) Patent Application Publication
(10) Pub. No.: US 2016/0034060 A1
(43) Pub. Date: Feb. 4, 2016

(54) TOUCH DISPLAY DEVICE with multiple alternating touch periods and display periods per frame

(71) Applicant: HIMAX TECHNOLOGIES LIMITED, Tainan City (TW)

(72) Inventors: Yu-Feng LIN, Tainan City (TW); Yaw-Guang CHANG, Tainan City (TW)

(21) Appl. No.: 14/449,136

(22) Filed: Jul. 31, 2014

(51) Int. Cl. G06F 3/041

(52) U.S. Cl. CPC G06F 3/041

(57) ABSTRACT

The touch display device includes a display panel and a panel driver. The display panel displays a video and to receive a touch operation. The panel driver includes a timing controller and a memory module. The timing controller generates a clock signal, each cycle of the clock signal including N display periods and N touch periods, the total time of the N display periods corresponding to a frame of a video signal, and the total time of the N display periods and the N touch periods corresponding to one cycle of the video signal, in which N is a positive integer. The panel driver alternately drives the panel to display the video during each of the N display periods and to detect the touch operation during each of the N touch periods. The memory module sequentially stores the image data of the video signal according to the clock signal.

### BACKGROUND

1. Technical Field

The present disclosure relates to a touch display device. More particularly, the present disclosure relates to a sensing circuit of a touch panel.

2. Description of Related Art

Touch display devices are used widely in electronic devices such as notebooks, personal digital assistants (PDAs), video cameras, and the like.

Users can perform the desired functions on the touch display device by touching/moving on the screen of the touch display device. However, as applications for panels with large-size or high resolution have become more and more popular, the sensibility of touch operations is required to be increased for providing a better user's experience.

Therefore, a heretofore-unaddressed need exists to address the aforementioned deficiencies and inadequacies.

### SUMMARY

One aspect of the present disclosure is to provide a touch display device. The touch display device includes a display panel and a panel driver. The display panel is configured to display a video and to receive a touch operation. The panel driver includes a timing controller and a memory module. The timing controller is configured to generate a clock signal, each cycle of the clock signal including N display periods and N touch periods, the total time of the N display periods corresponding to a frame of a video signal, and the total time of the N display periods and the N touch periods corresponding to one cycle of the video signal, in which N is a positive integer. The panel driver is configured to alternately drive the panel to display the video during each of the N display periods and to detect the touch operation during each of the N touch periods. The memory module is configured to sequentially store the image data corresponding to one of the N display period of the video signal according to the clock signal.

Another aspect of the present disclosure is to provide a control method for a touch display device. The control method includes the following steps: generating a clock signal by a timing controller, wherein each cycle of the clock signal including N display periods and N touch periods, the total time of the N display periods corresponding to a frame of a video signal, and the total time of the N display periods and the N touch periods corresponding to the one cycle of the video signal, in which N is a positive integer; and alternately driving the touch display device to display a video during each of the N display periods, and to detect a touch operation during each of the N touch periods.

In summary, the touch display device and the control method of the present disclosure are able to improve the sensibility of touch operations and to be implemented with small-size memory.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a touch display device according to one embodiment of the present disclosure;

FIG. 2A is waveforms illustrating the internal control signals in the touch display device shown in FIG. 1 according to one embodiment of the present disclosure;

FIG. 2B is a schematic diagram of the clock signal and related configurations of the touch display device shown in FIG. 1 according to one embodiment of the present disclosure;

FIG. 3 is a flow chart of a control method for the touch display device according to one embodiment of the present disclosure;

FIG. 4 is a schematic diagram of one cycle of the clock signal and related configurations of the touch display device shown in FIG. 1 according to one embodiment of the present disclosure;

FIG. 5 is a schematic diagram of one cycle of the clock signal and related configurations of the touch display device shown in FIG. 1 according to one embodiment of the present disclosure;

FIG. 6 is a schematic diagram of one cycle of the clock signal and related configurations of the touch display device shown in FIG. 1 according to one embodiment of the present disclosure;

FIG. 7 is a schematic diagram of one cycle of the clock signal and related configurations of the touch display device shown in FIG. 1 according to one embodiment of the present disclosure;

FIG. 8A is a waveform illustrating the configuration of the memory module shown in FIG. 1 according to one embodiment of the present disclosure;

FIG. 8B is a schematic diagram of the memory module shown in FIG. 1 according to one embodiment of the present disclosure; and

FIG. 8C is a schematic diagram of the memory module shown in FIG. 1 according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Although the terms “first,” “second,” etc., may be used herein to describe various elements, these elements should not be limited by these terms. These terms are used to distinguish one element from another.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

In this document, the term “coupled” may also be termed as “electrically coupled”, and the term “connected” may be termed as “electrically connected”. “Coupled” and “connected” may also be used to indicate that two or more elements cooperate or interact with each other.

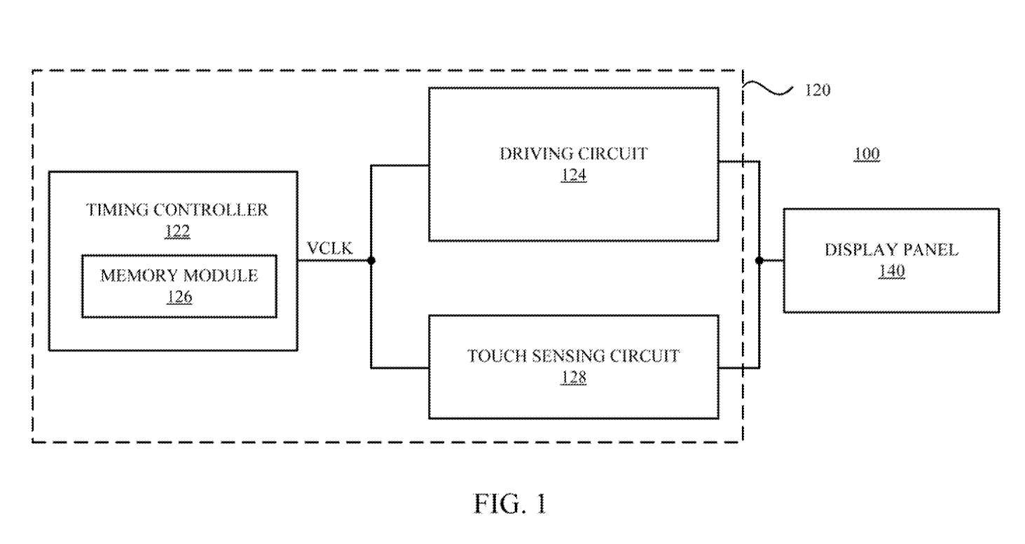

Reference is made to FIG. 1. FIG. 1 is a schematic diagram of a touch display device according to one embodiment of the present disclosure. As shown in FIG. 1, the touch display device 100 includes a panel driver 120 and a display panel 140. The display panel 140 is electrically coupled to the panel driver 120, and is configured to display a video and to receive a touch operation from users.

The panel driver 120 is configured to drive the display panel 140. In various embodiments, the panel driver 120 includes a timing controller 122, a driving circuit 124, a memory module 126, and a touch sensing circuit 128. The timing controller 122 is configured to generate a clock signal VCLK. The driving circuit 124 is electrically coupled to the timing controller 122, and is configured to drive the display panel 140 to display the video according to the clock signal VCLK. The memory module 126 is configured to store the image data of a video signal. The touch sensing circuit 128 is electrically coupled to the timing controller 122, and is configured to detect the touch operations performed on the display panel 120.

In some embodiments, as shown in FIG. 1, the memory module 126 can be integrated with the timing controller 122. In some other embodiments, the memory module 126 can be disposed outside of the timing controller 122. For example, the memory module 126 can be coupled between a video processing unit and the timing controller 122.

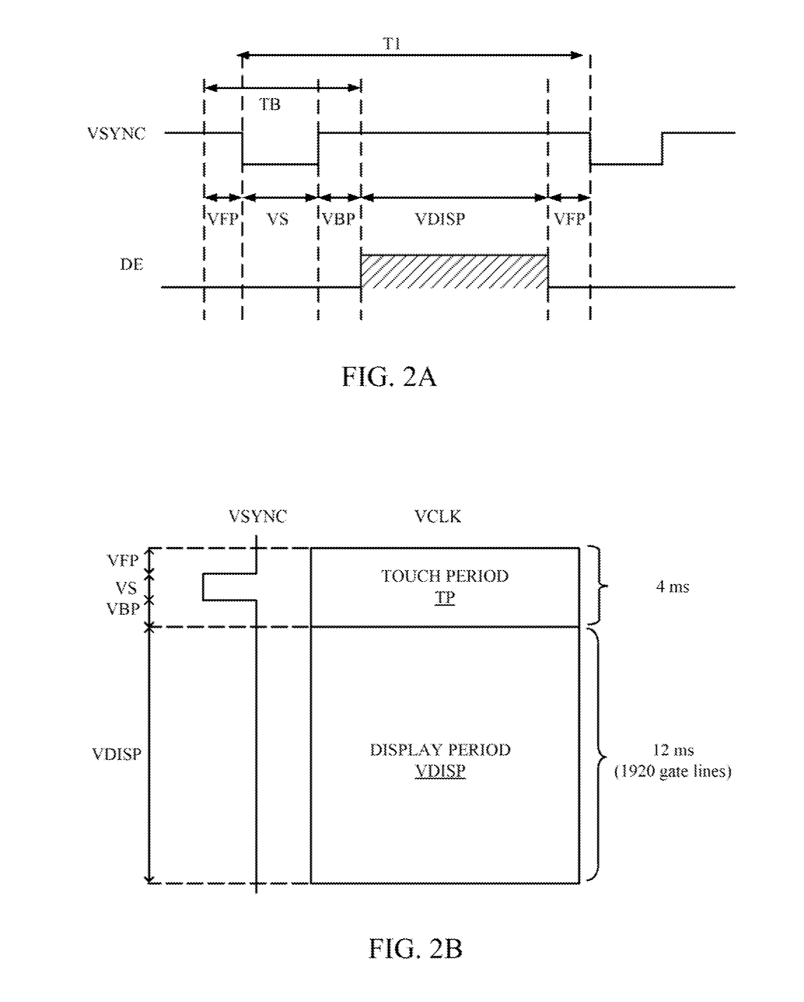

Reference is made to FIG. 2A. FIG. 2A is waveforms illustrating the internal control signals in the touch display device shown in FIG. 1 according to one embodiment of the present disclosure. As shown in FIG. 2A, in this embodiment, a vertical synchronization signal VSYNC signal is used for driving displays without touch application in some approaches. Data enable signal DE indicates that the corresponding image data in the driving circuit 124 is valid and can be read.

The vertical synchronization signal VSYNC includes a front porch period VFP, a back porch period VBP, an active period VS, and a display period VDISP, in which the total time of the front porch period VFP, the back porch period VBP, and the active period VS is defined as a blanking period TB. The front porch period VFP and the back porch period VBP represent a buffering time for processing the image data. The active period VS is used to notify the driving circuit 124 that transmission of a previous frame of the video signal is completed, and it is ready to transmit a next frame of the video signal. The display period VDISP is the time that the driving circuit 124 drives the pixels (not shown) of the display panel 140 to display the video. In other words, the display period VDISP corresponds to a frame of the video signal, and the cycle T1 (i.e., sum of the display period VDISP and the blanking period TB) of the clock signal VCLK corresponds to a cycle of the video signal.

Reference is made to FIG. 2B. FIG. 2B is a schematic diagram of the clock signal and related configurations of the touch display device shown in FIG. 1 according to one embodiment of the present disclosure.

As the display panel 140 does not display the image data of the video signal during the blanking period TB, the touch sensing circuit 128 can detect the touch operations on the display panel 140 during the blanking period TB (described as a touch period TP hereinafter). Therefore, in the clock signal VCLK, the touch period TP is configured to be followed by the display period VDISP. In other words, in each cycle of the clock signal VCLK, the touch sensing circuit 128 can detect the touch operations on the display panel 140 once after the display period VDISP.

For illustration, when the display panel 140 has a resolution of 1920×1080, i.e., a full high definition, each cycle of the clock signal VCLK is set to include one display period VDISP being about 12 milliseconds (ms) for driving the 1920 gate lines of the display panel 140 and one touch period TP being about 4 ms for sensing touch operations.

The following paragraphs provide certain embodiments related to the panel driver 120 to illustrate functions and applications thereof. However, the present disclosure is not limited to the following embodiments.

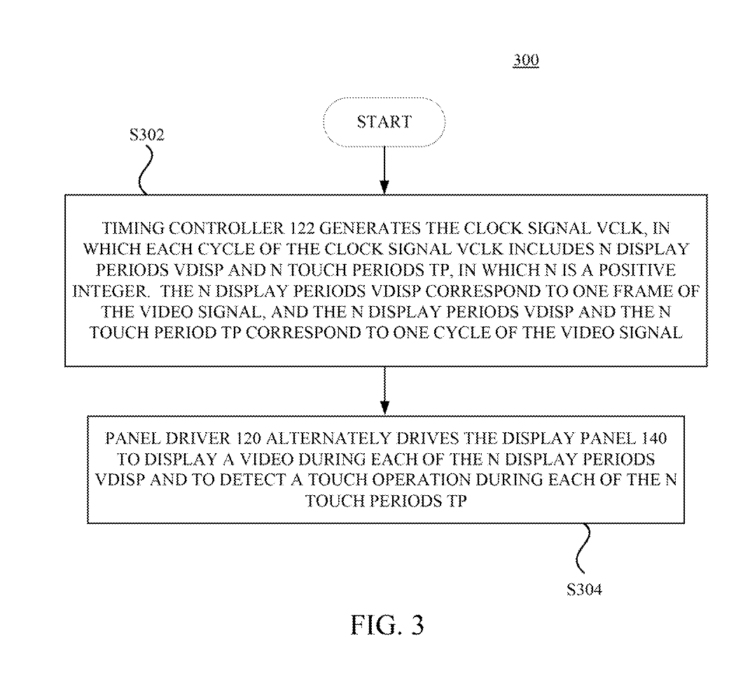

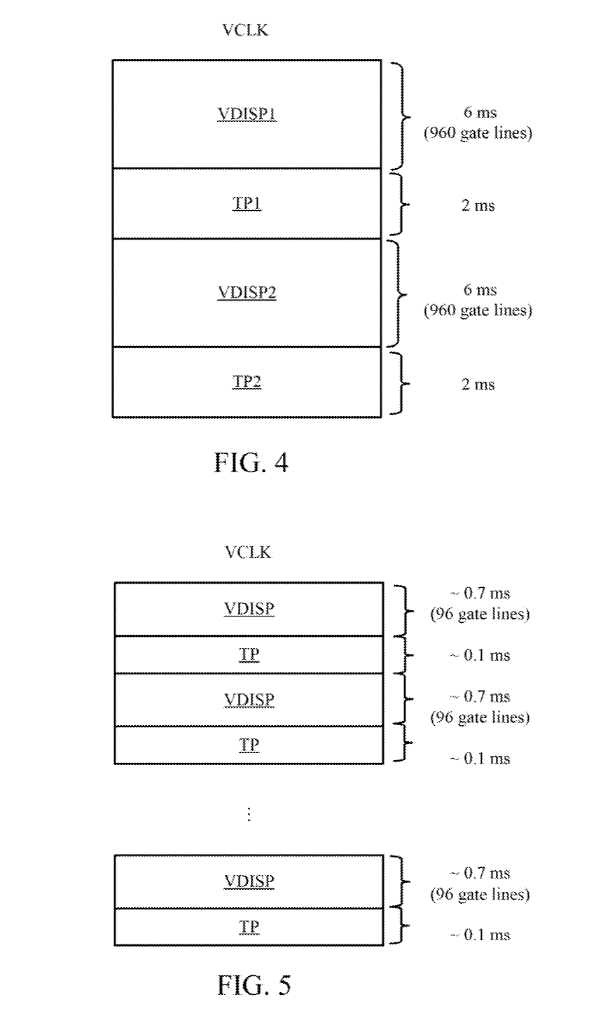

Reference is made to FIG. 3 and FIG. 4. FIG. 3 is a flow chart of a control method for the touch display device according to one embodiment of the present disclosure. FIG. 4 is a schematic diagram of one cycle of the clock signal and related configurations of the touch display device shown in FIG. 1 according to one embodiment of the present disclosure. For simplicity, the following descriptions are described with reference to FIG. 1, FIG. 3, and FIG. 4.

As shown in FIG. 3, the control method 300 includes step S302 and step 304. In step S302, the timing controller 122 generates the clock signal VCLK, in which each cycle of the clock signal VCLK includes N display periods VDISP and N touch periods TP, in which N is a positive integer. The N display periods VDISP correspond to one frame of the video signal, and the N display periods VDISP and the N touch period TP correspond to one cycle of the video signal.

In step S304, the panel driver 120 alternately drives the display panel 140 to display a video during each of the N display periods VDISP and to detect a touch operation during each of the N touch periods TP.

For illustration, reference is made to FIG. 4. In this embodiment, N=2. In other words, a cycle of the clock signal VCLK includes a first display period VDISP1, a second display period VDISP2, a first touch period TP1, and a second touch period TP2. It's noted that the total time of the first display period VDISP1 and the second display period VDISP2 is equal to one display period VDISP shown in FIG. 26. Similarly, the total time of the first touch period TP1 and the second touch period TP2 is equal to one touch period TP shown in FIG. 28. In other words, in this embodiment, the touch period TP shown in FIG. 2B is divided into the two touch periods TP1 and TP2, and display period VDISP shown in FIG. 26 is divided into the two display periods VDISP1 and VDISP2.

When the display panel 140 is a full high definition panel, each of the first display period VDISP1 and the second display period VDISP2 is set to about 6 ms for driving 960 gate lines, respectively, and each of the first touch period TP1 and the second touch period TP2 is set to about 2 ms for sensing the touch operation.

In various embodiments, the first display period VDISP1 and the second display period VDISP2 are arranged to be staggered with each other by the first touch period TP1 and the second touch period TP2. For example, the first display period VDISP1 and the second display period VDIP2 are separated by the first touch period TP1, and the first touch period TP1 and the second touch period TP2 are separated by the second display period VDISP2. In some embodiments, each of the first display period VDISP1 and the second display period VDISP2 is followed by one of the first touch period TP1 and the second touch period TP2. As shown in FIG. 4, the first display period VDISP1 is followed by the first touch period TP1, and the second display period VDISP2 is followed by the second touch period TP2, in which the first touch period TP1 is followed by the second display period VDISP2. In some other embodiments, the first touch period TP1 is followed by the first display period VDISP1, and the second touch period TP2 is followed by the second display period VDISP2.

With such configuration, the touch sensing circuit 128 can detect the touch operation two times in each cycle of the clock signal VCLK. As a result, the sensibility of the touch operation is improved.

Reference is made of FIG. 5. FIG. 5 is a schematic diagram of one cycle of the clock signal and related configurations of the touch display device shown in FIG. 1 according to one embodiment of the present disclosure.

In this embodiment, N is set to 20. In other words, a cycle of the clock signal VCLK includes 20 display periods VDISP, and 20 touch periods TP. When the display panel 140 is a full high definition panel, each display period VDISP is set to about 0.7 ms for driving 96 gate lines, respectively, and each touch period TP is set to about 0.1 ms for sensing the touch operation. One of person having ordinary skills in the art can adjust the sensibility of the touch operation by setting the number of N according to practical applications.

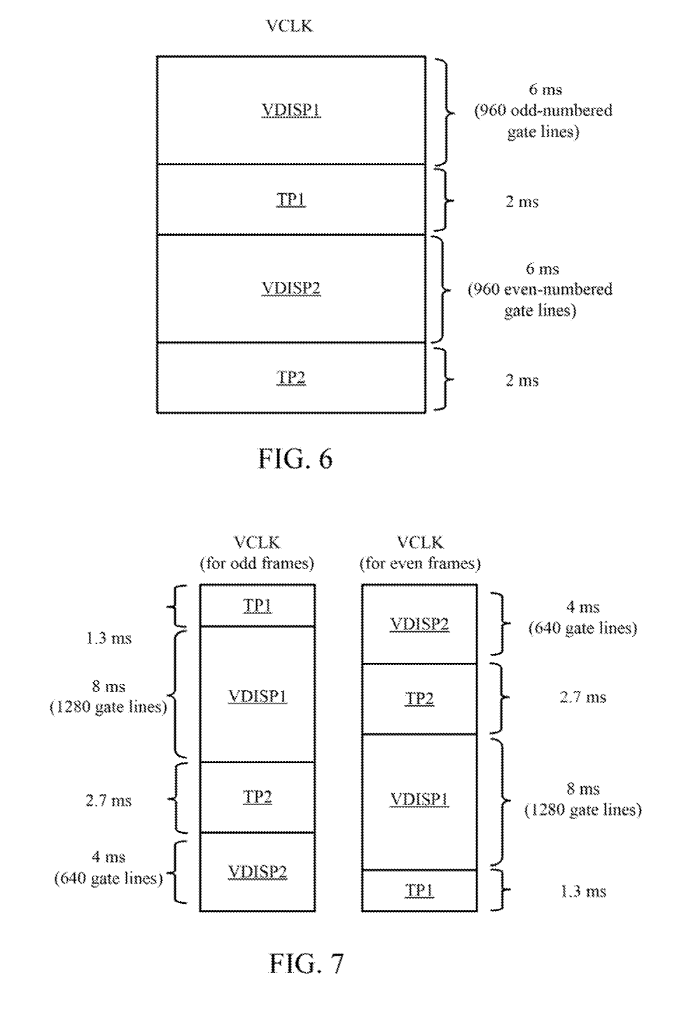

Reference is made to FIG. 6. FIG. 6 is a schematic diagram of one cycle of the clock signal and related configurations of the touch display device shown in FIG. 1 according to one embodiment of the present disclosure.

In various embodiments, the display panel 140 includes gate lines having odd-numbered gate lines and even-numbered gate lines. In this embodiment, as shown in FIG. 6, N is set to 2. Similarly, the first display period VDISP1 and the second display period VDISP2 are arranged to be staggered with each other by the first touch period TP1 and the second touch period TP2. During the first display period VDISP1, the panel driver 120 is configured to drive the 960 odd-numbered gate lines of the display panel 140. Alternatively, during the second display period VDISP1, the panel driver 120 is configured to drive the 960 even-numbered gate lines of the display panel 140.

Reference is made to FIG. 7. FIG. 7 is a schematic diagram of the clock signal and related configurations of the touch display device shown in FIG. 1 according to one embodiment of the present disclosure.

In this embodiment, N is set to 2. As shown in FIG. 7, the order of the first touch period TP1, the second touch period TP2, the first display period VDISP1, and the second display period VDISP2 are varied with the frames of the video signal.

For illustration, when the display panel 140 is a full high definition panel, the first touch period TP1 is set to about 1.3 ms, the second touch period TP2 is set to about 21 ms, the first display VDISP1 is set to about 8 ms for driving 1280 gate lines, and the second display VDISP2 is set to about 4 ms for driving 640 gate lines. When the display panel 140 displays odd frames of the video signal, the first touch period TP1 is followed by the first display period VDISP1, and the second touch period TP2 is followed by the second display period VDISP2, in which the first display period VDISP1 is followed by the second touch period TP2.

Alternatively, when the display panel 140 displays even frames of the video signal, the second display period VDISP2 is followed by the second touch period TP2, and the first display period VDISP1 is followed by the first touch period TP1, in which the first touch period TP2 the second display period VDISP2 is followed by the first display period VDISP1.

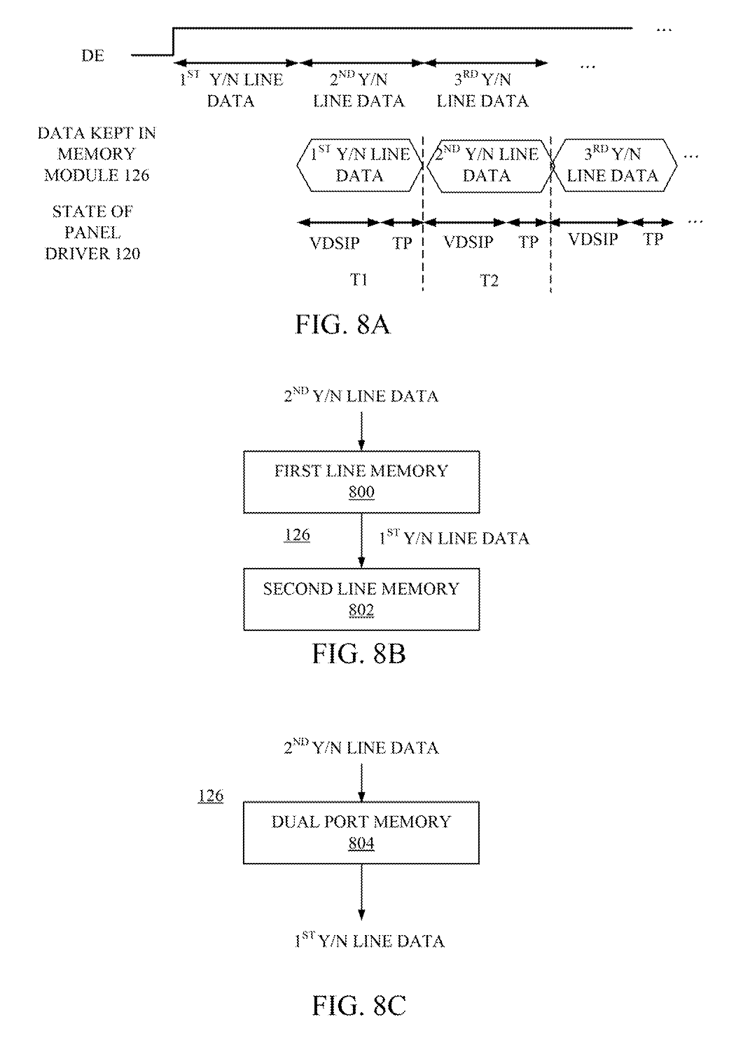

Reference is made to FIG. 8A-8B. FIG. 8A is a waveform illustrating the configuration of the memory module shown in FIG. 1 according to one embodiment of the present disclosure. FIG. 8B is a schematic diagram of the memory module shown in FIG. 1 according to one embodiment of the present disclosure.

In various embodiments, the resolution of the display panel 140 is denote as X*Y, in which X is the horizontal resolution, and Y is the vertical resolution. As every N display periods VDISP correspond to one frame of the video signal, the memory module 126 can just keep the image data with size of Y/N. In other words, each image data is regarded as an Y/N line data.

For illustration, as shown in FIG. 8A, as the panel driver 120 is configured to sequentially drive the display panel 140 to display the video according to the display periods VDISP of the clock signal VCLK, the memory module 126 can be configured to sequentially keep the image data corresponding to one of the N display periods VDISP.

For illustration, as shown in FIG. 8B, the memory module 126 includes a first line memory 800 and a second line memory 802. The first line memory 800 is configured to sequentially receive the Y/N data corresponding to one of the N display periods VDISP according to the clock signal VCLK. The second line memory 802 is configured to sequentially receive the Y/N line data from the first line memory 800, and to sequentially output the Y/N line data to the display panel 140 according to the clock signal VCLK.

To be explained in detail, the first line memory 800 receives the first Y/N line data during time T1. During time T2, the first line memory 800 transmits to the first Y/N line data to the second line memory, and the second line memory 802 is thus able to keep the first Y/N line data and outputs the first Y/N line data to the display panel 140. In the mean time, the first line memory 800 also receives the second Y/N line data during time T2. Therefore, by performing the repetitious operations above, the panel driver 120 can drive the display panel 140 to correctly display the video. In this embodiment, the first line memory 800 and the second line memory 802 form a ping-pang memory.

FIG. 8C is a schematic diagram of the memory module shown in FIG. 1 according to one embodiment of the present disclosure. As shown in FIG. 8C, in some other embodiments, the memory module 126 includes a dual port memory (i.e., two ports memory) 804 that is configured to sequentially receive and output the image data corresponding to one of the N display period VDISP according to the clock signal VCLK. For example, during time T2, the dual port memory 804 receives the second Y/N line data, and also outputs the first Y/N line data to the display panel 140.

Further, as mentioned above, the memory module 126 is only to keep the mage data corresponding to one of the N display periods, and thus the size of the memory module 126 can be reduced. For illustration, when N is set to 16 and the resolution of the display panel 140 is 1920*1080, the size of memory module 126 implemented in the ping-pong memory (i.e., the memory module 126 shown in FIG. 8B) is 2*1920*(1080/16) 24 bits, and the size of memory module 126 implemented in the dual port memory 804 shown in FIG. 8C is 1920*(1080/16)*24 bits, in which the 24 bits correspond to one image data of the video signal. Compared with the panel driver being required to store a full frame image data (ie, 1920*1080*24 bits) used in some approaches, the size of the memory module 126 can be significantly reduced. As a result, the cost of the touch display device 100 of the present disclosure can be saved.

In summary, the touch display device and the control method of the present disclosure are able to improve the sensibility of touch operations and to be implemented with small-size memory.

It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

1. A touch display device, comprising:
a display panel configured to display a video and to receive a touch operation; and
a panel driver, comprising:
a timing controller configured to generate a clock signal, each cycle of the clock signal comprising N display periods and N touch periods, the total time of the N display periods corresponding to a frame of a video signal, and the total time of the N display periods and the N touch periods corresponding to one cycle of the video signal, wherein N is a positive integer equal or greater than two, and the frame consisting of N line data,
wherein the panel driver is configured to alternately drive the panel to display the video during each of the N display periods and to detect the touch operation during each of the N touch periods; and
a memory module comprising a first line memory and a second line memory, wherein the first line memory receives only a first line data of the N line data corresponding to one of the N display periods during a first time; during a second time after the first time, the first line memory receives only a second line data of the N line data corresponding to another one of the N display periods and transmits the first line data to the second line memory, and the second line memory keeps the first line data and outputs the first line data to the display panel.

2. The touch display device of claim 1, wherein the total time of the N touch periods is equal to a sum of a front porch period, a back porch period, and an active period of a vertical synchronization signal.

3. The touch display device of claim 1, wherein two of the N display periods are separated by one of the N touch periods, and two of the N touch periods are separated by one of the N display periods.

4. The touch display device of claim 1, wherein each of the N display periods is followed by one of the N touch periods.

5. The touch display device of claim 1, wherein the order of the N touch periods and the N display periods are varied with the frames of the video signal.

6. The touch display device of claim 1, wherein each of the N touch periods is followed by one of the N display periods when the display panel displays odd frames of the video signal.

7. The touch display device of claim 6, wherein each of the N display periods is followed by one of the N touch periods when the display panel displays even frames of the video signal.

8. The touch display device of claim 1, wherein the display panel comprises a plurality of gate lines having odd-numbered gate lines and even-numbered gate lines, wherein when N=2, the panel driver is further configured to drive the odd-numbered gate lines during a first display period of the N display period, and to drive the even-numbered gate lines during a second display period of the N display periods, and each one of the first display period and the second display period is followed by one of a first touch period and a second touch period of the N touch periods.

9-10. (canceled)

11. A control method for a touch display device, comprising:
generating a clock signal by a timing controller, wherein each cycle of the clock signal comprising N display periods and N touch periods, the total time of the N display periods corresponding to a frame of a video signal, and the total time of the N display periods and the N touch periods corresponding to the one cycle of the video signal, wherein N is a positive integer equal or greater than two, and the frame consisting of N line data;
alternately driving the touch display device to display a video during each of the N display periods, and to detect a touch operation during each of the N touch periods;
receiving only a first line data of the N line data corresponding to one of the N display periods during a first time; and
receiving only a second line data of the N line data corresponding to another one of the N display periods, and transmitting the first line data to the display panel during a second time following the first time.

12. The control method of claim 11, wherein the total time of the N touch period periods is equal to a sum of a front porch period, a back porch period, and a active period of a vertical synchronization signal.

13. The control method of claim 11, wherein two of the N display periods are separated by one of the N touch periods, and two of the N touch periods are separated by one of the N display periods.

14. The control method of claim 11, wherein each of the N display periods is followed by one of the N touch periods.

15. The control method of claim 11, wherein the order of the N touch periods and the N display periods are varied with the frames of the video signal.

16. The control method of claim 11, wherein each of the N touch periods is followed by one of the N display periods when the touch display device is configured to display odd frames of the video signal.

17. The control method of claim 16, wherein each of the N display periods is followed by one of the N touch periods when the touch display device is configured to display even frames of the video signal.

18. The control method of claim 11, wherein when N=2, the step of alternately driving the touch display device comprises:
driving the odd-numbered gate lines of the touch display device during a first display period of the N display periods; and
driving the even-numbered gate lines of the touch display device during a second display period of the N display periods, wherein each one of the first display period and the second display period is followed by one of the first touch period and the second touch period.

19-20. (canceled)

21. A touch display device, comprising:
a display panel configured to display a video and to receive a touch operation; and
a panel driver, comprising:
a timing controller configured to generate a clock signal, each cycle of the clock signal comprising N display periods and N touch periods, the total time of the N display periods corresponding to a frame of a video signal, and the total time of the N display periods and the N touch periods corresponding to one cycle of the video signal, wherein N is a positive integer equal or greater than two, and the frame consisting of N line data,
wherein the panel driver is configured to alternately drive the panel to display the video during each of the N display periods and to detect the touch operation during each of the N touch periods; and
a dual port memory receiving only a first line data of the N line data corresponding to one of the N display periods during a first time,
wherein during a second time following the first time, the dual port memory receives only a second line data of the N line data corresponding to another one of the N display periods and transmits the first line data to the display panel.
